(19) United States
(12) Patent Application Publication
(10) Pub. No.: US 2024/0176682 A1
(43) Pub. Date: May 30, 2024

(54) COMPUTING DEVICE AND ITS CONVOLUTION DATA SHARING MECHANISMS

(71) Applicant: SigmaStar Technology Ltd., Xiamen (CN)

(72) Inventors: Chao Li, Shanghai (CN); Wei Zhu, Shanghai (CN); Bo Lin, Shanghai (CN)

(21) Appl. No.: 18/376,003

(22) Filed: Oct. 3, 2023

(30) Foreign Application Priority Data
Nov. 25, 2022 (CN) 202211491657.3

(51) Int. Cl. G06F 9/54; G06F 9/48

(52) U.S. Cl. CPC G06F 9/542; G06F 9/4881

(57) ABSTRACT

A computing device is coupled to an external memory and includes a first computing core and a second computing core. The first computing core includes a broadcasting circuit and is configured to obtain a target data from the external memory, store the target data in the broadcasting circuit, and use the target data to perform convolution operations. The second calculation core is configured to read the target data from the broadcasting circuit and use the target data to perform convolution operations.

This application claims the benefit of China application Serial No. 202211491657.3, filed on Nov. 25, 2022, the subject matter of which is incorporated herein by reference.

### BACKGROUND OF THE INVENTION

### 1. Field of the Invention

The present invention generally relates to computing devices, and, more particularly, to the mechanism of sharing convolution data among computing cores or convolution cores of artificial intelligence (AI) accelerators.

### 2. Description of Related Art

With the advancement of deep learning theory, the development and application of neural networks in the fields of machine learning and cognitive science have been rapid. The development of neural networks, regardless of their type (e.g., the Convolutional Neural Network (CNN), the Recurrent Neural Network (RNN)) or the number of layers (e.g., an 8-layer AlexNet network, a 152-layer ResNet network), has reached unprecedented heights. As a result, the complexity of network computing has also increased exponentially, posing even greater challenges to improve the computing power of AI accelerators.

To keep up with the rapidly increasing complexity of computations, multi-core has become the trend for many AI accelerators as the computing power reaches the bottleneck. However, memory bandwidth limitations make it difficult for multi-core accelerators to effectively utilize the computing resources.

### SUMMARY OF THE INVENTION

In view of the issues of the prior art, an object of the present invention is to provide a computing device and a computing core thereof, so as to make an improvement to the prior art.

According to one aspect of the present invention, a computing device is provided. The computing device is coupled to an external memory and includes a first computing core and a second computing core. The first computing core includes a broadcasting circuit and is configured to obtain a target data from the external memory, store the target data in the broadcasting circuit, and use the target data to perform a first convolution operation. The second computing core is configured to read the target data from the broadcasting circuit and use the target data to perform a second convolution operation.

According to another aspect of the present invention, a computing core is provided. The computing core is coupled to an external memory. The external memory stores a target data. The computing core includes a memory and a convolution core. The memory is configured to store the target data. The convolution core includes a broadcasting circuit and a multiply accumulate. The convolution core reads the target data from the memory, stores the target data in the broadcasting circuit, and provides the target data to the multiply accumulate.

The technical means embodied in the embodiments of the present invention can solve at least one of the problems of the prior art. Therefore, compared to the prior art, the present invention can reduce the memory bandwidth requirements of the computing device.

These and other objectives of the present invention no doubt become obvious to those of ordinary skill in the art after reading the following detailed description of the preferred embodiments with reference to the various figures and drawings.

### BRIEF DESCRIPTION OF THE DRAWINGS

FIG. 1 is a functional block diagram of a computing device according to an embodiment of the present invention.

FIG. 2 is a more detailed functional block diagram of the convolution core according to an embodiment of the present invention.

FIG. 3 is the functional block diagram of a broadcasting circuit according to an embodiment of the present invention.

FIG. 4 is the functional block diagram of a data loading circuit according to an embodiment of the present invention.

FIG. 5 is the state machine of the data loading circuit according to an embodiment of the present invention.

FIG. 6 is the functional block diagram of a weight loading circuit according to an embodiment of the present invention.

FIG. 7 is the state machine of the weight loading circuit according to an embodiment of the present invention.

FIG. 8 shows a functional block diagram of a computing device according to another embodiment of the present invention.

FIG. 9 shows a functional block diagram of a computing device according to another embodiment of the present invention.

### DETAILED DESCRIPTION OF THE EMBODIMENTS

The following description is written by referring to terms of this technical field. If any term is defined in this specification, such term should be interpreted accordingly. In addition, the connection between objects or events in the below-described embodiments can be direct or indirect provided that these embodiments are practicable under such connection. Said “indirect” means that an intermediate object or a physical space exists between the objects, or an intermediate event or a time interval exists between the events.

The disclosure herein includes a computing device and its convolution data sharing mechanisms. On account of that some or all elements of the computing device could be known, the detail of such elements is omitted provided that such detail has little to do with the features of this disclosure, and that this omission nowhere dissatisfies the specification and enablement requirements. A person having ordinary skill in the art can choose components or steps equivalent to those described in this specification to carry out the present invention, which means that the scope of this invention is not limited to the embodiments in the specification.

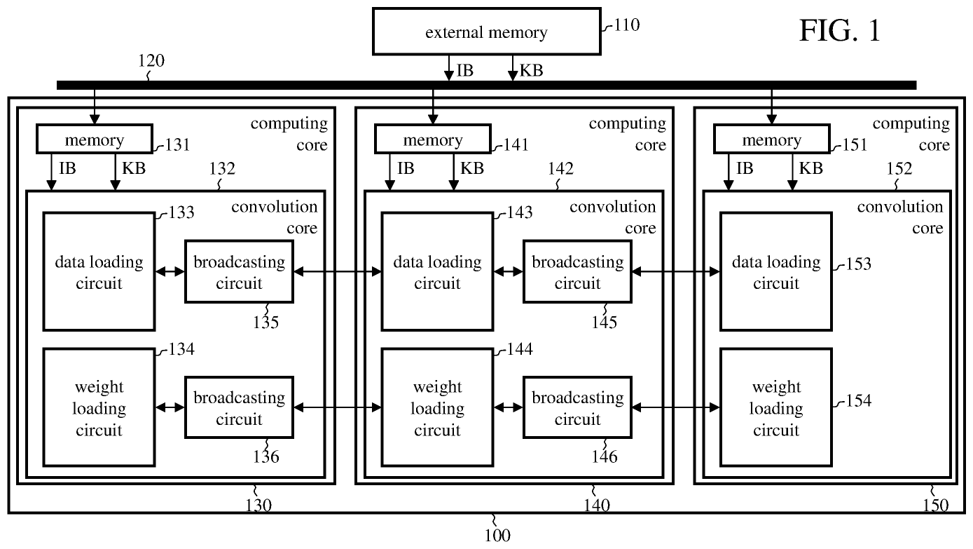

FIG. 1 is a functional block diagram of a computing device 100 according to an embodiment of the present invention. The computing device 100 is coupled to an external memory (e.g., a Dynamic Random Access Memory (DRAM)) 110 via a memory bus 120. The computing device 100 has a multi-core architecture and includes a computing core 130, a computing core 140, and a computing core 150. The computing core 130 includes a memory (e.g., a cache) 131 and a convolution core 132. The convolution core 132 includes a data loading circuit 133, a weight loading circuit 134, a broadcasting circuit 135, and a broadcasting circuit 136. The computing core 140 includes a memory 141 and a convolution core 142. The convolution core 142 includes a data loading circuit 143, a weight loading circuit 144, a broadcasting circuit 145, and a broadcasting circuit 146. The computing core 150 includes a memory 151 and a convolution core 152. The convolution core 152 includes a data loading circuit 153 and a weight loading circuit 154. The computing device 100 may be a part of an electronic device such as an image processing chip.

In some cases, the computing core 130, the computing core 140, and the computing core 150 can read the data required for the convolution operation (including but not limited to the input feature data IB and the weight data KB) from the external memory 110 via the memory bus 120 and then store the data in the memory 131, the memory 141, and the memory 151, respectively. In some embodiments, the memory 131, the memory 141, and the memory 151 are the L2 caches of the computing core 130, the computing core 140, and the computing core 150, respectively.

The convolution core 132 (142, 152) is used to perform convolution operations. The data loading circuit 133 (143, 153) is used to load the input feature data IB, and the weight loading circuit 134 (144, 154) is used to load the weight data KB. To share the input feature data IB with other computing cores (or convolution cores), the data loading circuit 133 (143) further stores the input feature data IB in the broadcasting circuit 135 (145). To share the weight data KB with other computing cores (or convolution cores), the weight loading circuit 134 (144) further stores the weight data KB in the broadcasting circuit 136 (146). In other words, in some cases, the data loading circuit 143 (153) may obtain the input feature data IB from the broadcasting circuit 135 (145) (instead of from the memory 141 (151), which is equivalent to not obtaining the input feature data IB from the external memory 110). As a result, the computing device 100 can reduce the number of accesses to the external memory 110 (i.e., reduce the memory bandwidth requirements). Similarly, in some cases, the weight loading circuit 144 (154) may obtain the weight data KB from the broadcasting circuit 136 (146) (instead of from the memory 141 (151), which is equivalent to not obtaining the weight data KB from the external memory 110).

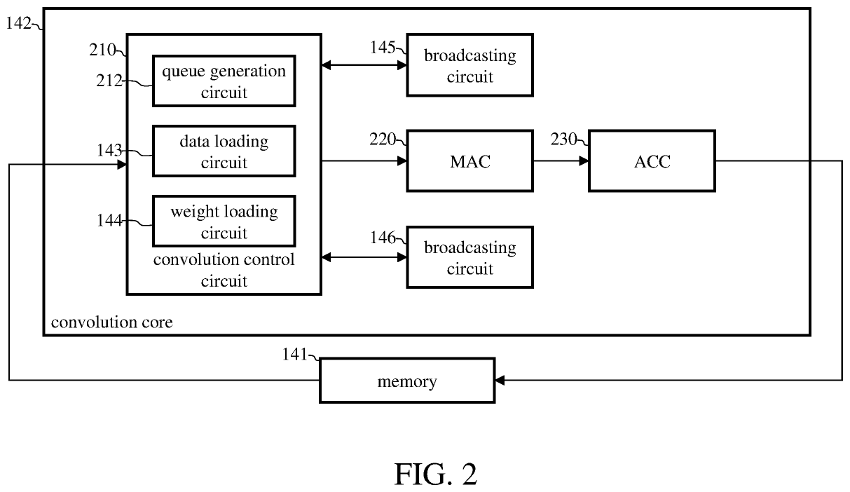

FIG. 2 is a functional block diagram of the convolution core in greater detail according to an embodiment of the present invention. FIG. 2, which uses the convolution core 142 as an example, illustrates the internal circuitry of a convolution core. The convolution core 132 has the same or similar circuitry. The convolution core 142 includes a broadcasting circuit 145, a broadcasting circuit 146, a convolution control circuit 210, a multiply accumulate (MAC) 220, and an accumulator (ACC) 230.

The convolution control circuit 210 is responsible for operations including pipeline control of the convolution operation, reading of the input feature data IB and the weight data KB, and data processing. The convolution control circuit 210 includes a queue generation circuit 212, a data loading circuit 143, and a weight loading circuit 144. The queue generation circuit 212 processes the convolution instructions from the upper layer (e.g., a central processing unit (CPU), a microprocessor, a microcontroller, a micro-processing unit, or a digital signal processing (DSP) circuit, not shown), classifies the related parameters in the convolution instructions and stores them for subsequent use of other circuits (including but not limited to the data loading circuit 143 and/or the weight loading circuit 144), and is responsible for dividing the data into multiple tiles and then triggering the data loading circuit 143 and the weight loading circuit 144 multiple times to load the input feature data IB and the weight data KB, respectively, from the memory 141.

The MAC 220 is the calculation unit of the convolution core 142 and primarily performs the multiply-accumulate operation (cross-multiplying the input feature data IB and the weight data KB and then accumulating the products). The MAC 220 is equipped with MAC arrays of different sizes, depending on the computing power required.

The ACC 230 performs convolution accumulation operations, including accumulation on channels and accumulation on convolution core sizes, etc., and also performs some post-processing tasks of convolution. The ACC 230 stores intermediate accumulation results or final calculation results in the memory 141.

People having ordinary skill in the art are familiar with the operational details of the MAC 220 and the ACC 230; the details are omitted for brevity.

In some embodiments, the convolution core 132 and the convolution core 142 operate in a broadcasting mode or a receiving mode according to a convolution instruction issued from an upper layer (details will be discussed below).

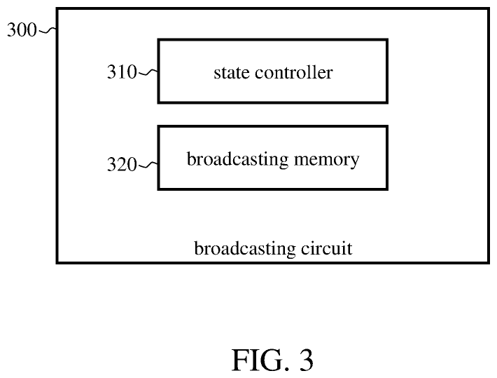

FIG. 3 is a functional block diagram of the broadcasting circuit according to an embodiment of the present invention. The broadcasting circuits 135, 136, 145, and 146 in FIG. 1 can be embodied by the broadcasting circuit 300. The broadcasting circuit 300 includes a state controller 310 and a broadcasting memory 320. The state controller 310 controls or changes the state of the broadcasting circuit 300. The broadcasting memory 320 is used for storing the input feature data IB or the weight data KB. In some embodiments, the broadcasting memory 320 is a first-in-first-out (FIFO) memory.

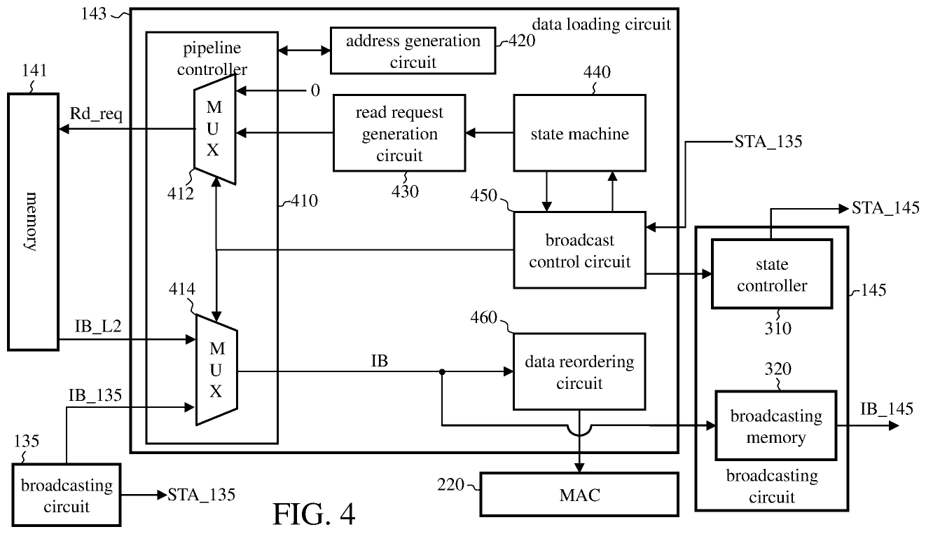

FIG. 4 is a functional block diagram of the data loading circuit according to an embodiment of the present invention. The data loading circuit (taking the data loading circuit 143 as an example) includes a pipeline controller 410, an address generation circuit 420, a read request generation circuit 430, a state machine 440, a broadcast control circuit 450, and a data reordering circuit 460. The data loading circuit 133 and the data loading circuit 153 have the same or similar internal circuitry as the data loading circuit 143.

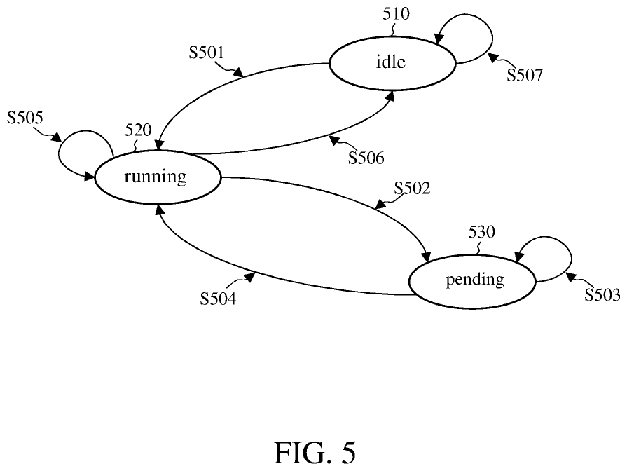

The pipeline controller 410 includes two selection units (a multiplexer (MUX) 412 and a MUX 414). Under the control of the broadcast control circuit 450, the read request Rd_req outputted by the MUX 412 is either an actual request generated by the read request generation circuit 430 or a dummy request (e.g., a value of “0,” indicating that the data loading circuit 143 does not perform a read operation on the memory 141). When the read request Rd_req is an actual request, its address is generated by the address generation circuit 420. For example, the address generation circuit 420 calculates the address in the memory 141 for storing the next data according to the coordinate of the currently processed pixel on the image. Under the control of the broadcast control circuit 450, the MUX 414 outputs either the input feature data IB_L2 read from the memory 141 or the input feature data IB_135 read from the broadcasting circuit 135. The broadcast control circuit 450 reads the state STA_135 of the broadcasting circuit 135 and provides the state STA_135 to the state machine 440. The broadcast control circuit 450 also performs control according to the mode of the convolution core 142 (the broadcasting mode or the receiving mode) and the state machine 440. The state machine 440 will be discussed in detail below with reference to FIG. 5.

Continuing with FIG. 4, the data reordering circuit 460 reorders and duplicates the obtained input feature data IB to make the input feature data IB conform to the accumulation structure of the MAC 220. After obtaining the input feature data IB (i.e., the input feature data IB_L2 or the input feature data IB_135), the data loading circuit 143 uses the data reordering circuit 460 to rearrange the input feature data IB for use of the MAC 220 and provides the input feature data IB to the broadcasting circuit 145 (more specifically, stores the input feature data IB in the broadcasting memory 320 of the broadcasting circuit 145), so that the convolution core coupled to the broadcasting circuit 145 (e.g., the convolution core 152 of FIG. 1) can obtain the input feature data IB from the broadcasting circuit 145 (i.e., the input feature data IB_145 outputted by the broadcasting circuit 145). The state STA_145 is the state of the broadcasting circuit 145.

FIG. 5 is a state machine of the data loading circuit according to an embodiment of the present invention. The state machine in FIG. 5 includes three states: an idle state 510, a running state 520, and a pending state 530. The state machine of FIG. 5 will be discussed in greater detail according to the following example where the convolution core 132 is used as the broadcasting end (i.e., operated in the broadcasting mode, in which the convolution core 132 broadcasts the input feature data IB to other convolution cores) and the convolution core 142 is used as the receiving end (i.e., operated in the receiving mode, in which the convolution core 142 receives the input feature data IB from other convolution cores). Reference is made to FIGS. 1 to 5 for the following discussions.

For the convolution core 132 (the broadcasting end), FIG. 5 includes the following steps.

Step S501: When the convolution core 132 receives a convolution instruction, the state machine 440 of the data loading circuit 133 enters the running state 520 from the idle state 510.

Step S502: When any of the following three situations occurs, the state machine 440 of the data loading circuit 133 enters the pending state 530 from the running state 520: (1) the corresponding weight data KB (i.e., the weight data KB required for the current convolution operation) is not ready yet (i.e., the weight loading circuit 134 has not yet obtained the corresponding weight data KB); (2) the data loading circuit 133 has processed the last pixel of an image; or (3) the state of the broadcasting circuit 135 indicates that the broadcasting memory 320 is “full.” When situation (1) or situation (2) occurs, the data loading circuit 133 enters the pending state 530 to wait for the weight loading circuit 134 to obtain the corresponding weight data KB. When situation (3) occurs, the data loading circuit 133 enters the pending state 530 to wait for the state of the broadcasting circuit 135 to become “empty.” If none of these three situations occurs, the data loading circuit 133 performs step S505 in the running state 520.

Step S503: The data loading circuit 133 continues to wait in the pending state 530 for the weight data KB to be ready, or for the state of the broadcasting circuit 135 indicating that the broadcasting memory 320 is “empty.”

Step S504: The weight data KB is ready or the state of the broadcasting circuit 135 indicates that the broadcasting memory 320 is “empty,” and the state machine 440 of the data loading circuit 133 returns to the running state 520 from the pending state 530.

Step S505: In the running state 520, the broadcast control circuit 450 of the data loading circuit 133 controls the pipeline controller 410 to send a read request Rd_req to read the input feature data IB from the memory 131 (instead of from the broadcasting circuit of other convolution cores because the convolution core 132 is the broadcasting end), and notifies the state controller 310 of the broadcasting circuit 135 that the data loading circuit 133 has started to read the input feature data IB from the memory 131. In response to the read operation of the data loading circuit 133, the state controller 310 of the broadcasting circuit 135 changes the state of the broadcasting circuit 135 to be “full.”

Step S506: After the data loading circuit 133 has finished reading the input feature data IB from the memory 131, the data loading circuit 133 enters to the idle state 510 from the running state 520.

Step S507: The data loading circuit 133 waits for the next convolution instruction in the idle state 510.

For the convolution core 142 (the receiving end), FIG. 5 also includes steps S501-S507, which are the same for the convolution core 132 (the broadcasting end) except for steps S502-S505, and the details for the same steps are omitted for brevity.

Step S502 of the data loading circuit 143 is similar to step S502 of the data loading circuit 133, except that, for the convolution core 142, the above situation (3) is: the state of the broadcasting circuit 135 indicates that the broadcasting memory 320 is “empty.” For situation (3), the data loading circuit 143 waits in the pending state 530 for the data loading circuit 133 to start reading the input feature data IB from the memory 131 (step S503). After the state of the broadcasting circuit 135 becomes “full” (i.e., the data loading circuit 133 has started to read the input feature data IB from the memory 131), the data loading circuit 143 enters the running state 520 from the pending state 530 (step S504). In step S505, the broadcast control circuit 450 controls the MUX 414 of the data loading circuit 143 to output the input feature data IB_135 read from the broadcasting circuit 135, and notifies the state controller 310 of the broadcasting circuit 135 that the data loading circuit 143 has read the input feature data IB from the broadcasting memory 320 of the broadcasting circuit 135. In response to the read operation in which the data loading circuit 143 reads the input feature data IB from the broadcasting memory 320 of the broadcasting circuit 135, the state controller 310 of the broadcasting circuit 135 changes the state of the broadcasting circuit 135 to be “empty.”

The operating timings of the convolution core 132 and the convolution core 142 are discussed below. The convolution core 132 sends a read request Rd_req in the running state 520 to read the input feature data IB_L2 and notifies the state controller 310 of the broadcasting circuit 135 so that the state controller 310 of the broadcasting circuit 135 changes the state of the broadcasting circuit 135 to “full” (i.e., the broadcasting circuit 135 changes its state in response to the input feature data IB read via the convolution core 132 from the memory 131). When the convolution core 142 detects the state change of the broadcasting circuit 135, the state machine 440 of the convolution core 142 enters the running state 520 (at this time the convolution core 132 has waited for two clock cycles), and the convolution core 142 issues a read request Rd_req to access the broadcasting circuit 135. Note that the pipeline controller 410 of the convolution core 142 delays the read request Rd_req by three clock cycles before sending it to ensure that when the broadcasting circuit 135 receives the read request Rd_req from the convolution core 142, the data loading circuit 133 of the convolution core 132 has just finished writing the input feature data IB into the broadcasting memory 320 of the broadcasting circuit 135.

Continuing the previous paragraph, that is to say, in the clock cycle immediately after the convolution core 132 finishes writing the input feature data IB into the broadcasting circuit 135, the read request Rd_req of the convolution core 142 reaches the broadcasting circuit 135. This allows the convolution core 142 to read from the broadcasting circuit 135 the input feature data IB that has just been written into the broadcasting circuit 135 by the convolution core 132 in the previous clock cycle. Moreover, the read input feature data IB arrives at the convolution core 142 after a delay of two clock cycles on the path. Therefore, when the convolution core 142 obtains the input feature data IB, it has just waited for five clock cycles (since the time the read request Rd_req was issued).

As can be seen from the discussion in the previous two paragraphs, with such a precise timing design, the convolution core 142 sends the read request Rd_req one clock cycle later than the convolution core 132, and also obtains the input feature data IB one clock cycle later than the convolution core 132. In this way, the electronic device to which the computing device 100 belongs can operate smoothly. The above delays can be controlled by the pipeline controller 410.

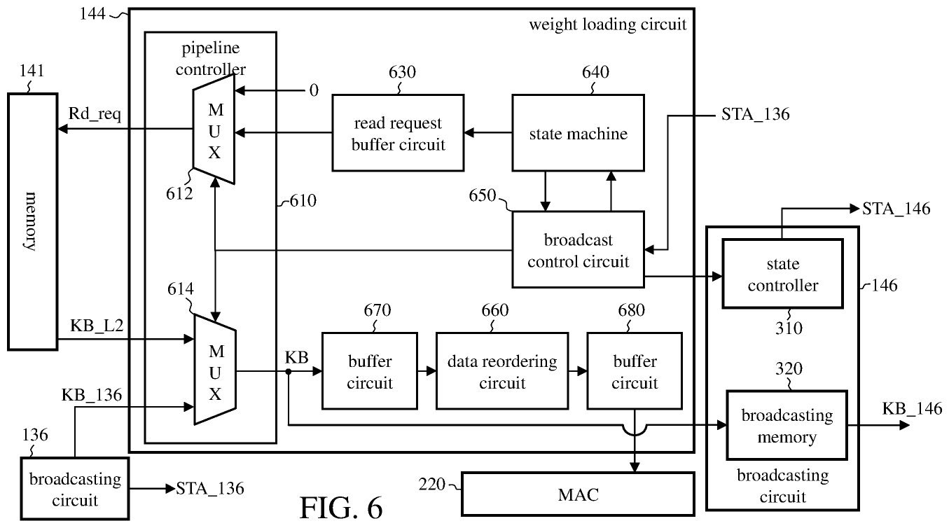

FIG. 6 is a functional block diagram of a weight loading circuit according to an embodiment of the present invention. The weight loading circuit (taking the weight loading circuit 144 as an example) includes a pipeline controller 610, a read request buffer circuit 630, a state machine 640, a broadcast control circuit 650, a data reordering circuit 660, a buffer circuit 670, and a buffer circuit 680. The pipeline controller 610 includes a MUX 612 and a MUX 614. The weight loading circuit 134 and the weight loading circuit 154 have the same or similar internal circuitry as the weight loading circuit 144.

The pipeline controller 610, the broadcast control circuit 650, and the data reordering circuit 660 are similar to the pipeline controller 410, the broadcast control circuit 450, and the data reordering circuit 460 respectively, so the details are omitted for brevity.

In a convolution operation, the input feature data IB is scanned over via the weight data KB, which means that the weight data KB does not change for a period of time (depending on the size of the tiles of the image); therefore, unlike like the data loading circuit 143, the weight loading circuit 144 does not need to access the memory 141 every clock cycle. More specifically, after obtaining a set of weight data KB, the weight loading circuit 144 notifies the data loading circuit 143 that the weight data KB is ready, and then the data loading circuit 143 begins its task; meanwhile, the weight loading circuit 144 obtains the next set of weight data KB in advance and store it inside the weight loading circuit 144. In this way, after finishing processing a tile, the data loading circuit 143 can immediately start the calculation of the next tile without waiting for the weight data KB to be ready, which improves the convolution performance.

Note that because the weight loading circuit 144 needs to prefetch the weight data KB, the depth of the read request buffer circuit 630 is two (for storing two consecutive read requests (or read instructions)). As a result, the weight loading circuit 144 contains two buffer circuits: a buffer circuit 670 and a buffer circuit 680. The depth of the buffer circuit 670 and the set of the buffer circuit 680 are both 1, meaning that each stores one set of weight data KB. The data reordering circuit 660 is disposed between the buffer circuit 670 and the buffer circuit 680. Since the weight data KB does not change for a period of time, the reordered data (i.e., the output of the data reordering circuit 660) needs to be kept in the buffer circuit 680. The buffer circuit 670 is used to store the next set of weight data KB prefetched. After the data in the buffer circuit 680 is released, the data in the buffer circuit 670 is processed by the data reordering circuit 660 before entering the buffer circuit 680, and then the data in the buffer circuit 670 is released to make room for the next set of weight data KB.

Continuing with FIG. 6, after obtaining the weight data KB (i.e., the weight data KB_L2 or the weight data KB_136), the weight loading circuit 144 writes the weight data KB into the buffer circuit 670 and provides the weight data KB to the broadcasting circuit 146 (more specifically, storing the weight data KB to the broadcasting memory 320 of the broadcasting circuit 146), so that the convolution core (e.g., the convolution core 152 in FIG. 1) coupled to the convolution core 142 can obtain the weight data KB from the broadcasting circuit 146 (that is, the weight data KB_146 outputted by the broadcasting circuit 146). Because the depth of the read request buffer circuit 630 is 2, the depth of the broadcasting memory 320 of the broadcasting circuit 146 is also two (i.e., two sets of weight data KB can be stored). The state STA_146 is the state of the broadcasting circuit 146.

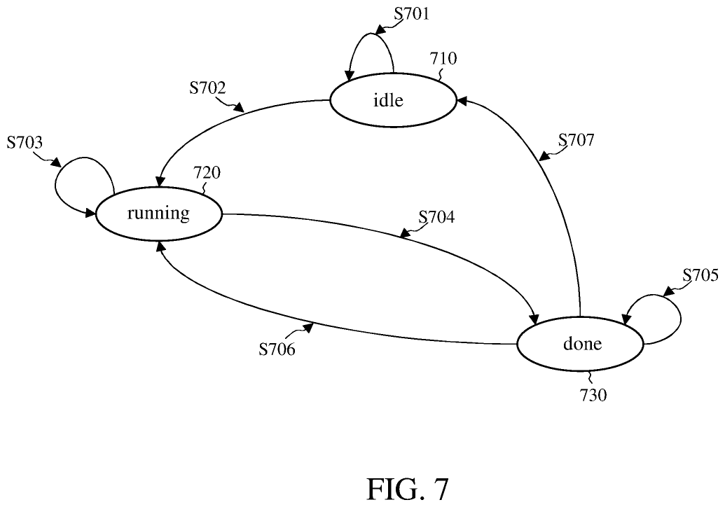

Under the control of the broadcast control circuit 650, the MUX 614 of the pipeline controller 610 outputs either the weight data KB_L2 (i.e., the weight loading circuit 144 obtains the weight data KB from the memory 141) or weight data KB_136 (i.e., the weight loading circuit 144 obtains the weight data KB from the broadcasting circuit 136). The broadcast control circuit 650 reads the state STA_136 of the broadcasting circuit 136 and provides the state STA_136 to the state machine 640. The broadcast control circuit 650 also performs control according to the mode of the convolution core 142 (broadcasting mode or receiving mode) and the state machine 640. The state machine 640 will be discussed in detail below with reference to FIG. 7.

FIG. 7 shows the state machine of the weight loading circuit according to an embodiment of the present invention. The state machine in FIG. 7 includes three states: an idle state 710, a running state 720, and a done state 730. The state machine of FIG. 7 will be discussed below according to the following example where the convolution core 132 is used as the broadcasting end and the convolution core 142 is used as the receiving end. Reference is made to FIGS. 1-3 and FIGS. 6-7 for the following discussion.

For the convolution core 132 (the broadcasting end), FIG. 7 includes the following steps.

Steps S701 and S702: The weight loading circuit 134 waits in the idle state 710 to receive a convolution instruction. When the convolution core 132 receives the convolution instruction, the weight loading circuit 134 determines whether the broadcasting memory 320 of the broadcasting circuit 136 is “empty.” If the broadcasting memory 320 of the broadcasting circuit 136 is not “empty,” the weight loading circuit 134 continues to wait in the idle state 710 for the state controller 310 of the broadcasting circuit 136 to change the state of the broadcasting circuit 136 (step S701). If the broadcasting memory 320 is “empty,” the state machine 640 of the weight loading circuit 134 enters the running state 720 from the idle state 710 (step S702).

Steps S703 and S704: The weight loading circuit 134 keeps reading the weight data KB in the running state 720 (step S703); then, the weight loading circuit 134 enters the done state 730 when the number of weight data KB read reaches a required amount (i.e., when a set of weight data KB is read) (step S704).

Steps S705, S706 and S707: The weight loading circuit 134 writes the weight data KB read in step S703 into the broadcasting memory 320 of the broadcasting circuit 136 in the done state 730, waits for the weight data KB in the buffer circuit 670 to be moved to the buffer circuit 680, and then writes the weight data KB read in step S703 into the buffer circuit 670 (step S705). Next, the weight loading circuit 134 determines whether all the read requests in the read request buffer circuit 630 have been processed. If the determination result is no, the weight loading circuit 134 returns to the running state 720 to read the next set of weight data KB (step S706); if the determination result is yes, the weight loading circuit 134 enters the idle state 710 to wait for the next convolution instruction (step S707).

For the convolution core 142 (the receiving end), FIG. 7 also includes steps S701-S707, which are the same for the convolution core 132 (the broadcasting end) except for step S703, and the details for the same steps are omitted for brevity. For the convolution core 142, the weight loading circuit 144 reads the weight data KB from the broadcasting circuit 136 (not from the memory 141) in step S703.

In some embodiments, similar to the input feature data IB, the convolution core 142 sends a read request Rd_req one clock cycle later than the convolution core 132 and obtains the weight data KB one clock cycle later than the convolution core 132, and it also takes five clock cycles from sending the read request Rd_req to obtaining the weight data KB.

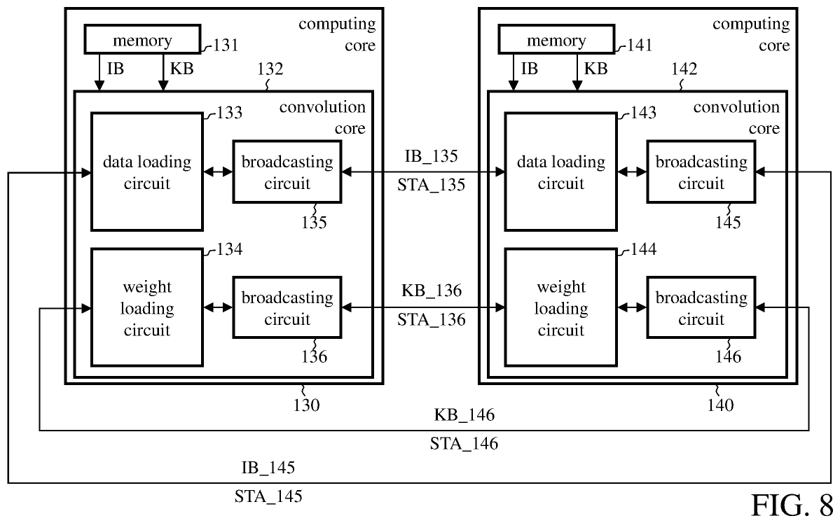

FIG. 8 shows a functional block diagram of a computing device according to another embodiment of the present invention. In the embodiment of FIG. 8, the broadcasting circuit 145 and the broadcasting circuit 146 of the convolution core 142 are respectively coupled to the data loading circuit 133 and the weight loading circuit 134 of the convolution core 132. That is to say, the data loading circuit 133 and the weight loading circuit 134 can read the input feature data IB and the weight data KB from the broadcasting circuit 145 and the broadcasting circuit 146, respectively.

More specifically, when the convolution core 132 is used as a broadcasting end to read the first input feature data IB (the data of the current network layer) from the external memory 110 via the memory 131 and shares the first input feature data IB, the convolution core 142 can read the second input feature data IB (the data of the next network layer, which is different from the first input feature data IB) from the external memory 110 via the memory 141. Then, after the calculation of the current network layer is finished, the convolution core 142 switches to the broadcasting end to share the second input feature data IB with the convolution core 132. That is to say, when two convolution cores are connected to form a closed loop as shown in FIG. 8, the two convolution cores alternately operate in the broadcasting mode and the receiving mode (which is an equivalent of achieving the effect of ping-pong reading of the external memory 110 by the two convolution cores), which can not only reduce the bandwidth requirements of the external memory 110, but also speed up the overall convolution operation (because the convolution core 132 and the convolution core 142 process different convolution data at substantially the same time).

Continuing with FIG. 8, in some embodiments, the circuits of the convolution core 132 and the convolution core 142 are identical, the codes are identical, and the connection interfaces are symmetrical, which is conducive to connecting the convolution core 132 and the convolution core 142 into the closed loop as shown in FIG. 8.

Continuing with FIG. 8, in some embodiments, the clock used by the convolution core 132 and the clock used by the convolution core 142 are 180 degrees out of phase, which can prevent instantaneous large power consumption due to the convolution core 132 and the convolution core 142 starting the convolution operation at the same time. However, in some other embodiments, the convolution core 132 and the convolution core 142 can operate according to the same clock.

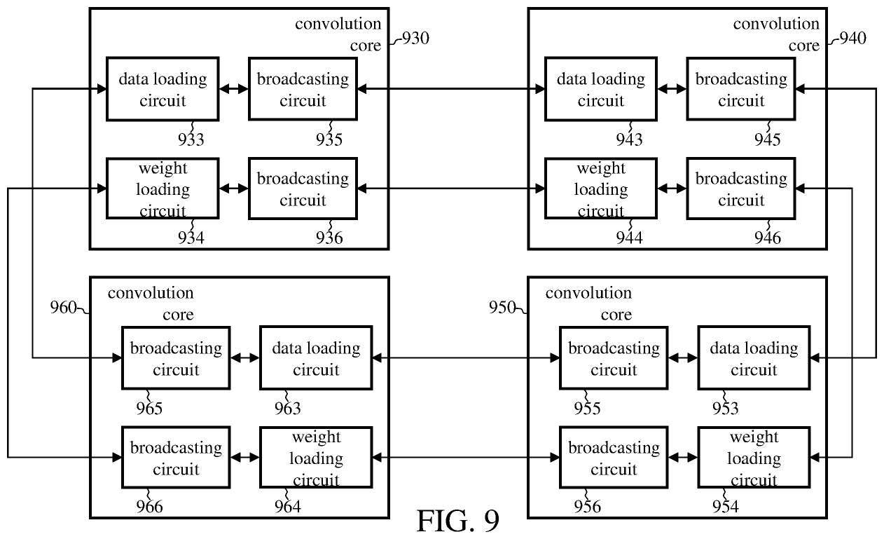

FIG. 9 shows a functional block diagram of a computing device according to another embodiment of the present invention. In the embodiment of FIG. 9, the computing device includes four convolution cores: the convolution core 930, the convolution core 940, the convolution core 950, and the convolution core 960. The convolution core 930 (940, 950, 960) includes a data loading circuit 933 (943, 953, 963), a weight loading circuit 934 (944, 954, 964), a broadcasting circuit 935 (945, 955, 965), and a broadcasting circuit 936 (946, 956, 966). The four convolution cores 930, 940, 950, and 960 are connected to form a closed loop. People having ordinary skill in the art can understand the connection and operational details of the circuit in FIG. 9 based on the discussions of FIG. 8, so the details are omitted for brevity.

To sum up, by sharing data among multiple convolution cores (or computing cores) of a computing device, the present invention greatly reduces the bandwidth requirement for accessing the external memory 110, thereby reducing the bandwidth costs. In addition, in system applications, since the convolution cores (or computing cores) are independent of each other, they can: (1) share the input feature data IB and read their respective weight data KB to calculate a layer of network data at the same time; or (2) share the weight data KB and read their respective input feature data IB to calculate different block areas of an image at the same time. In this way, the full utilization of the computing resources of the computing device can be achieved.

As discussed above, memory bandwidth requirements can be reduced by sharing at least one of the input feature data IB and the weight data KB between convolution cores (or computing cores).

The input feature data IB and weight data KB are intended to illustrate the invention by way of example and not to limit the scope of the claimed invention. People having ordinary skill in the art may apply the present invention to other types of convolution data in accordance with the foregoing discussions.

Various functional components or blocks have been described herein. As appreciated by persons skilled in the art, in some embodiments, the functional blocks can preferably be implemented through circuits (either dedicated circuits, or general purpose circuits, which operate under the control of one or more processors and coded instructions), which typically comprise transistors or other circuit elements that are configured in such a way as to control the operation of the circuitry in accordance with the functions and operations described herein. As further appreciated by persons skilled in the art, the specific structure or interconnections of the circuit elements can typically be determined by a compiler, such as a register transfer language (RTL) compiler. RTL compilers operate upon scripts that closely resemble assembly language code, to compile the script into a form that is used for the layout or fabrication of the ultimate circuitry. Indeed, RTL is well known for its role and use in the facilitation of the design process of electronic and digital systems.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A computing device coupled to an external memory, comprising:
a first computing core comprising a broadcasting circuit, wherein the first computing core is configured to obtain a target data from the external memory, store the target data in the broadcasting circuit, and use the target data to perform a first convolution operation; and
a second computing core configured to read the target data from the broadcasting circuit and use the target data to perform a second convolution operation.

2. The computing device of claim 1, wherein the broadcasting circuit comprises:
a broadcasting memory configured to store the target data; and
a state controller configured to control a state of the broadcasting circuit;
wherein the first computing core checks the state before storing the target data into the broadcasting memory, and the second computing core checks the state before reading the target data from the broadcasting memory.

3. The computing device of claim 2, wherein the first computing core comprises a data reordering circuit, the first computing core further comprises a multiply accumulate performing a multiply-accumulate operation based on an output of the data reordering circuit, and the first computing core further provides the target data to the data reordering circuit after reading the target data.

4. The computing device of claim 3, wherein the first computing core further comprises:
a first buffer circuit for storing the target data; and
a second buffer circuit for storing the output of the data reordering circuit;
wherein the data reordering circuit is coupled between the first buffer circuit and the second buffer circuit.

5. The computing device of claim 2, wherein the first computing core further comprises a weight loading circuit, and the weight loading circuit stores two consecutive read requests.

6. The computing device of claim 2, wherein the second computing core further comprises:
a pipeline controller coupled to the broadcasting circuit and the external memory; and
a broadcast control circuit configured to control, according to a convolution instruction received by the second computing core, the pipeline controller to obtain data from the external memory or read data from the broadcasting memory.

7. The computing device of claim 2, wherein the broadcasting memory is a first-in first-out memory.

8. The computing device of claim 1, wherein the broadcasting circuit is a first broadcasting circuit, the target data is a first target data, the second computing core comprises a second broadcasting circuit, and the second computing core further uses a second target data to perform the second convolution operation, the second computing core obtains the second target data from the external memory and stores the second target data in the second broadcasting circuit, the first computing core obtains the second target data from the second broadcasting circuit, and the first computing core further uses the second target data to perform the first convolution operation, the first target data being different from the second target data.

9. The computing device of claim 1, wherein the target data is an input feature data of at least one of the first convolution operation and the second convolution operation.

10. The computing device of claim 1, wherein the target data is a weight data of at least one of the first convolution operation and the second convolution operation.

11. A computing core coupled to an external memory, wherein the external memory stores a target data, the computing core comprising:
a memory configured to store the target data; and
a convolution core comprising a broadcasting circuit and a multiply accumulate, wherein the convolution core reads the target data from the memory, stores the target data in the broadcasting circuit, and provides the target data to the multiply accumulate.

12. The computing core of claim 11, wherein the broadcasting circuit comprises:
a broadcasting memory configured to store the target data; and
a state controller configured to control a state of the broadcasting circuit;
wherein the convolution core checks the state before storing the target data in the broadcasting memory.

13. The computing core of claim 12, wherein the convolution core comprises a data reordering circuit configured to reorder the target data, and the multiply accumulate performs a multiply-accumulate operation according to an output of the data reordering circuit.

14. The computing core of claim 13, wherein the convolution core further comprises:
a first buffer circuit configured to store the target data; and
a second buffer circuit configured to store the output of the data reordering circuit;
wherein the data reordering circuit is coupled between the first buffer circuit and the second buffer circuit.

15. The computing core of claim 12, wherein the convolution core further comprises a weight loading circuit, and the weight loading circuit stores two consecutive read requests.

16. The computing core of claim 12, wherein the broadcasting memory is a first-in first-out memory.

17. The computing core of claim 12, wherein the state controller changes the state in response to a read operation the convolution core reads the target data from the memory.

18. The computing core of claim 11, wherein the target data is an input feature data of a convolution operation.

19. The computing core of claim 11, wherein the target data is a weight data of a convolution operation.
